(19) United States
(12) Patent Application Publication
(10) Pub. No.: US 2015/0224921 A1
(43) Pub. Date: Aug. 13, 2015

(54) METHOD AND DEVICE FOR CONTROLLING A REAR FOG LIGHT OF A MOTOR VEHICLE

(71) Applicant: RENAULT S.A.S., BOULOGNE-BILLANCOURT (FR)

(72) Inventors: Paul Henry Matha, Guyancourt (FR); Michel Mahe, Guyancourt (FR)

(73) Assignee: RENAULT s.a.s., Boulogne-Billancourt (FR)

(21) Appl. No.: 14/426,907

(22) PCT Filed: Jul. 31, 2013
(86) PCT No.: PCT/FR2013/051845

§ 371 Date: Mar. 26, 2015

(30) Foreign Application Priority Data
Sep. 7, 2012 (FR) 1258377

(51) Int. Cl. B60Q 1/30; H05B 37/02; B60Q 1/00

(52) U.S. Cl. CPC B60Q 1/30; B60Q 1/0076; H05B 37/0227

(57) ABSTRACT

Method of controlling a rear fog light of a motor vehicle whose lamp is intended to be powered with a nominal supply voltage, comprising in the presence of a command to turn on said lamp, a reduction of the supply voltage of the lamp of said light in the presence of an exterior temperature of the vehicle that is greater than a threshold temperature and possibly of a speed of the vehicle that is below a threshold speed for a duration at least equal to a threshold duration.

The invention relates to motor vehicles, and more particularly to the control of the one or more rear fog lights of such a vehicle.

At the present time, the rear fog lights of a vehicle are of a substantial size due to the need for them to withstand thermally the switching-on of the rear fog light during the daytime when stationary. In fact, in such a situation, the temperature inside the fog light climbs rapidly to 150° C. and will continue to climb to 180° C. if the fog light continues to operate for a certain amount of time. Also, making fog lights of a relatively large size, for example having a surface area in the order of 50 cm², permits the utilization in the production of these fog lights of plastic materials having an industrially reasonable cost while limiting the risk of melting of these plastic materials during the increase in the temperature of the fog lights.

However, it is desirable at the present time to design fog lights having reduced overall dimensions, which increases the risk of melting of the plastic materials that are used at the present time.

According to one embodiment and mode of implementing the invention, a method and a device for controlling a rear fog light of a vehicle are proposed, limiting the risk of melting of the plastic materials that are utilized for this fog light while utilizing plastic materials having an industrially reasonable cost.

Proposed according to one aspect of the invention is a method of controlling a rear fog light of a motor vehicle, the lamp of which is intended to be supplied with a nominal supply voltage, comprising, in the event of a command to switch on said lamp, a supply at nominal voltage of the lamp of said light, which supply is influenced by an external temperature threshold of the vehicle.

Said supply at full voltage may be further influenced by a speed threshold of the vehicle.

According to one embodiment, in the event of said command to switch on said lamp, said supply of said lamp with the nominal voltage is validated in the event of a speed of the vehicle that is greater than or equal to the speed threshold, or in the event of an external temperature that is lower than or equal to the temperature threshold.

The method may comprise a reduction in the supply voltage in the event of an external temperature that is greater than the temperature threshold.

Said reduction in the supply voltage may be validated when the external temperature is greater than the temperature threshold for a period at least equal to a threshold time.

Proposed according to another aspect is a control device for a rear fog light of a motor vehicle, the lamp of which is intended to be supplied with a nominal supply voltage, comprising a control input to receive a command to switch on said lamp, a first input to receive information in respect of the external temperature of the vehicle, and means of control configured, in the event of a command to switch on said lamp, to supply the lamp at nominal voltage subject to receiving information to the effect that the external temperature is lower than a temperature threshold.

According to one mode of implementation, the device comprises a second input to receive information in respect of the speed of the vehicle, in such a way as to supply the lamp at nominal voltage subject to receiving information to the effect that the speed of the vehicle is greater than a speed threshold.

The means of control may in addition be configured, in the event of a command to switch on said lamp, to reduce supply voltage in the event of an external temperature that is greater than the temperature threshold.

The means of control may in addition be configured to reduce the supply voltage when the external temperature is greater than the temperature threshold for a period at least equal to a threshold time, for example as determined by a time-out.

The reduced voltage value may lie in the range between 0 V and 9 V.

Other advantages and characterizing features of the invention will be appreciated from a perusal of the detailed description of embodiments and modes of implementation, that are in no way restrictive, and of the accompanying drawings, in which:

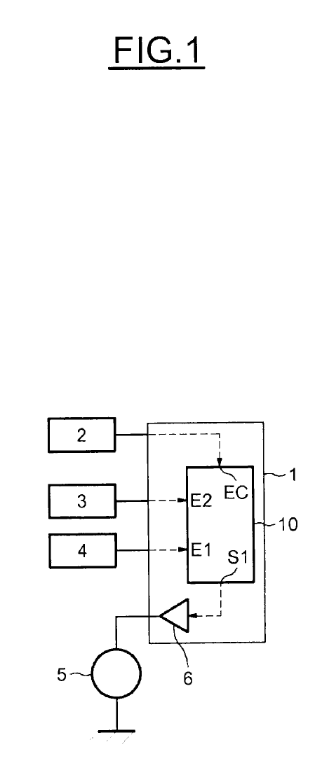

FIG. 1 illustrates schematically a mode of implementation of a device according to the invention,

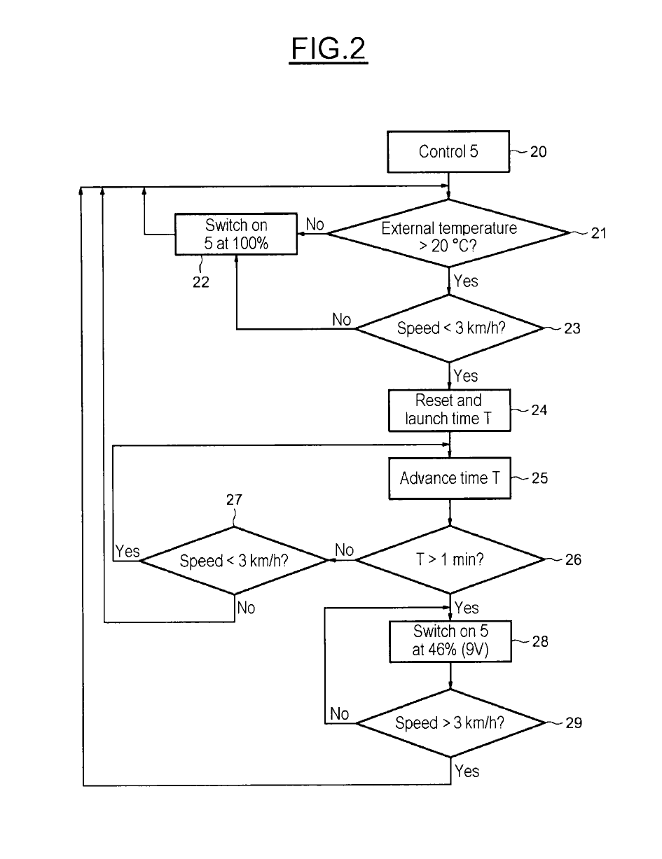

FIG. 2 illustrates schematically an embodiment of a method according to the invention, and

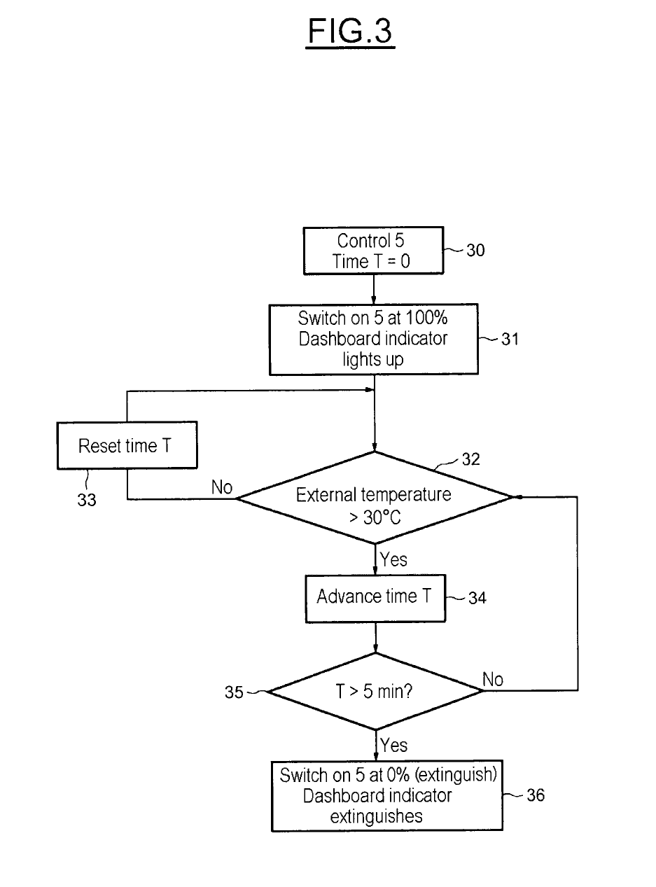

FIG. 3 illustrates schematically a simplified embodiment of the method according to the invention with a reduction in voltage to zero.

In FIG. 1, the reference 1 generally designates a computer connected to a control block 2 for the activation of one or a plurality of fog lights. This block 2 may be a control beneath the steering wheel, for example.

The computer 1 is also connected to a device 3 for measuring the speed of the vehicle, for example coupled to the computer for preventing locking of the wheels (ABS). The computer 1 is also coupled to a sensor 4 for the external temperature. The computer 1 comprises means of control 10, for example a control logic produced in the form of a software module and including a control input BC for receiving the command for the activation of the one or more fog lights originating from the block 2, a first input E1 for receiving information, originating from the sensor 4, in respect of the external temperature of the vehicle, and a second input E2 for receiving information, originating from the measurement device 3, in respect of the speed of the vehicle.

The means of control 10 include an output S1 delivering a signal activating an electronic switch 6 controlling the power delivered to the lamp of the fog light, in a conventional manner, for example by chopping the current (PMW system: Pulse Width Modulation).

According to one embodiment of the invention, a method is proposed for controlling a rear fog light of a motor vehicle, the lamp of which is intended to be supplied with a nominal supply voltage, this method comprising, in the event of a command to switch on said lamp, a reduction in the supply voltage of the lamp of said light in the event of an external temperature of the vehicle that is greater than a threshold temperature and a speed of the vehicle that is lower than a threshold speed for a period at least equal to a threshold time.

On the other hand, in the event of said command to switch on said lamp, the lamp is supplied with the nominal voltage in the event of a speed of the vehicle that is greater than or equal to the threshold speed, or in the event of an external temperature that is lower than said threshold temperature.

In other words, when the speed of the vehicle is zero or very low, and under certain conditions of external temperature, the supply voltage of the lamp of the fog light is reduced in order to ensure that the latter generates less heat. If, on the other hand, the vehicle is restarted, the lamp is supplied once more with the nominal supply voltage.

Such a command makes it possible to remain within the regulations and to lessen the thermal load, thereby making it possible to achieve a significant saving in size in order, for example, to move from a fog light surface area of 50 cm² to a surface area of 30 cm².

As far as the physical implementation is concerned, the means of control of the device are configured, in the event of a command to switch on said lamp, to reduce the supply voltage of the lamp in the event of an external temperature that is greater than a threshold temperature and in the event of a speed of the vehicle that is lower than a threshold speed for a period at least equal to a threshold time.

The means of control are also further configured, in the event of a command to switch on said lamp, to supply said lamp with the nominal voltage in the event of a speed of the vehicle that is greater than or equal to the threshold speed or in the event of an external temperature that is lower than said threshold temperature.

FIG. 2 illustrates such an embodiment.

In this figure, it can be appreciated that, in the event of the reception 20 of a command to switch on the lamp 5 being given by the driver, the means of control 10 initially test the external temperature in relation to a threshold temperature in a stage 21.

In the example described here, the threshold temperature is considered to be equal to 20° C. In fact, it is assumed that fog is not normally present above 20° C.

Furthermore, it is assumed that the cooling of the fog light is sufficient in the event of an external temperature of less than 20° C.

Under these conditions, if the external temperature is less than 20° C., the means of control 10 then control the switching-on of the lamp 5 of the fog light at 100% (stage 22), which is equivalent to supplying the lamp with its nominal supply voltage, for example 13.5 Volts.

On the other hand, if the external temperature is greater than 20° C., the means of control 10 then test the value of the speed of the vehicle in relation to a threshold speed (stage 23).

The threshold speed in this case is selected to be equal to 3 km/hour.

In the event of the speed being greater than 3 km/hour, the means of control 10 then control the switching-on of the lamp 5 of the fog light at 100% (stage 22), which is equivalent to supplying the lamp with its nominal supply voltage, for example 13.5 Volts.

If, on the other hand, the speed is less than 3 km/hour, the means of control 10 then set a time counter (stage 24).

In stage 25, this time counter is advanced and, in stage 26, the means of control 10 test whether the elapsed time since resetting has reached a predefined threshold time T, which in this case is considered to be equal to 1 minute.

In the event of the time exceeding the threshold time T, the means of control 10 then control the switching-on of the lamp 5 with a reduced power, for example at 46% of the nominal power.

In other words, the means of control reduce the supply voltage of the lamp 5 in order to bring it, for example, to about 6 Volts (stage 28).

As long as the speed of the vehicle remains below the threshold speed (3 km/hour) (stage 29), the lamp 5 will continue to be supplied with the reduced supply voltage.

On the other hand, as soon as the speed becomes greater than the threshold speed, it will return to stage 21.

Furthermore, in stage 26, as long as the threshold time T is not reached, the means of control will test (stage 27) the speed of the vehicle in relation to the threshold speed. As long as this speed remains below the threshold speed, the counter is advanced. On the other hand, as soon as the speed becomes greater than the threshold speed, it will return to stage 21.

Furthermore, during the return to this stage 21, if the conditions of temperature and speed are fulfilled once more, the lamp is resupplied at the nominal voltage.

This method of control makes it possible to lessen the thermal load and to reduce the size of the fog light. It is thus possible to move from a size of 50 cm² to a size of 30 cm².

FIG. 3 illustrates a variant for the control of the fog light which does not take into account any speed-related information.

In a stage 30, the time counter (time-out T) is set to zero.

In stage 31, the lamp 5 is supplied at 100%, that is to say at the nominal voltage.

The means of control then test the value of the external temperature at the temperature threshold (stage 32). This is considered to be equal to 30° C. in this embodiment.

If the external temperature is below or equal to the temperature threshold, the time counter is reset (stage 33).

Otherwise, the counter is advanced (stage 34) and a test is performed to establish whether the value of the counter has reached a threshold time T that is considered in this case to be equal to 5 min (stage 35).

If the time is greater than or equal to T, the lamp is then supplied with a reduced supply voltage (stage 36), which in the present case is equal to 0 Volt. In other words, in this example, the lamp 5 is extinguished.

1. A method of controlling a rear fog light of a motor vehicle, the lamp of which is intended to be supplied with a nominal supply voltage, comprising, in the event of a command to switch on said lamp, a supply at nominal voltage of the lamp of said light, which supply is influenced by an external temperature threshold of the vehicle.

2. The method as claimed in claim 1, in which said supply at full voltage is further influenced by a speed threshold of the vehicle.

3. The method as claimed in claim 1, in which, in the event of said command to switch on said lamp, said supply of said lamp with the nominal voltage is validated in the event of a speed of the vehicle that is greater than or equal to the speed threshold, or in the event of an external temperature that is lower than or equal to the temperature threshold.

4. The method as claimed in claim 1, comprising a reduction in the supply voltage in the event of an external temperature that is greater than the temperature threshold.

5. The method as claimed in claim 4, in which said reduction in the supply voltage is validated when the external temperature is greater than the temperature threshold for a period at least equal to a threshold time.

6. A control device for a rear fog light of a motor vehicle, the lamp of which is intended to be supplied with a nominal supply voltage, comprising a control input to receive a command to switch on said lamp, a first input to receive information in respect of the external temperature of the vehicle, and means of control configured, in the event of a command to switch on said lamp, to supply the lamp at nominal voltage subject to receiving information to the effect that the external temperature is lower than a temperature threshold.

7. The device as claimed in claim 6, comprising a second input to receive information in respect of the speed of the vehicle, in such a way as to supply the lamp at nominal voltage subject to receiving information to the effect that the speed of the vehicle is greater than a speed threshold.

8. The device as claimed in claim 6, in which the means of control are in addition configured, in the event of a command to switch on said lamp, to reduce the supply voltage in the event of an external temperature that is greater than the temperature threshold.

9. The device as claimed in claim 8, in which the means of control are in addition configured to reduce the supply voltage when the external temperature is greater than the temperature threshold for a period at least equal to a threshold time.

10. The device as claimed in claim 8, in which the means of control are configured to reduce the supply voltage to a reduced voltage value in the range between 0 V and 9 V.
